(19) United States
(12) Patent Application Publication
(10) Pub. No.: US 2019/0386897 A1
(43) Pub. Date: Dec. 19, 2019

(54) SYSTEM TO GENERATE CLOUD RESOURCE DIAGRAMS

(71) Applicant: Microsoft Technology Licensing, LLC, Redmond, WA (US)

(72) Inventor: Dheeraj GUNDRA, Hyderabad (IN)

(21) Appl. No.: 16/008,620

(22) Filed: Jun. 14, 2018

(51) Int. Cl. H04L 12/26; H04L 29/06; H04L 29/08; G06F 8/10; G06F 17/30

(52) U.S. Cl. CPC H04L 43/045; H04L 43/06; G06F 17/30997; H04L 67/32; G06F 8/10; H04L 63/0807

(57) ABSTRACT

A system includes transmission, to a cloud service provider, of a request for metadata of at least two cloud resources associated with a cloud resource group, reception of the metadata of the at least two cloud resources from the cloud service provider, the metadata comprising one or more dependencies and properties associated with each of the at least two cloud resources, and automatic generation of a diagram of the at least two cloud resources based on the received metadata, the diagram depicting at least one of the one or more dependencies and properties of the at least two cloud resources.

### BACKGROUND

Generally, a cloud service provider delivers a cloud service to a customer via the internet. A cloud service consists of resources which operate in conjunction with one another to provide the desired functionality of the cloud service. Resources may include, but are not limited to, storage, virtual machines, load balancers, databases, and key vaults.

Each resource includes various properties and dependencies to one or more other resources. The resources and their properties/dependencies may be specified to various degrees by the customer and/or the cloud service provider. For example, a customer may request a certain amount of storage, processing power and backup capacity, and the cloud service provider may allocate resources to the customer accordingly. In another example, a customer simply requests a desired functionality (e.g., a Web-based storefront) from a cloud service provider, and the cloud service provider allocates the required resources to the customer in response thereto.

An architecture diagram is a useful tool for understanding the resources assigned to a customer as well as the dependencies and properties of the resources. Conventional systems for generating an architecture diagram require deep technical knowledge of cloud resources and their interrelationships, as well as proficient usage of a diagramming tool to illustrate these elements. Systems are therefore desired to efficiently generate accurate and useful cloud resource architecture diagrams. Such systems may also facilitate the diagramming of a particular subset of resources of a cloud service.

### BRIEF DESCRIPTION OF THE DRAWINGS

FIG. 1 illustrates an architecture to generate a cloud service resource diagram according to some embodiments.

FIG. 2 illustrates hierarchies of subscriptions, resource groups and resources according to some embodiments.

FIG. 3 is a representation of cloud resource metadata according to some embodiments.

FIG. 4 is a representation of cloud resource metadata according to some embodiments.

FIG. 5 is a flow diagram of a process to generate a cloud service resource diagram according to some embodiments.

FIG. 6 illustrates an architecture to generate a cloud service resource diagram according to some embodiments.

FIG. 7 illustrates a user interface of a diagramming tool according to some embodiments.

FIG. 8 illustrates a user interface of a diagramming tool according to some embodiments.

FIG. 9 illustrates a computing system to generate a cloud service resource diagram according to some embodiments.

### DETAILED DESCRIPTION

The following description is provided to enable any person in the art to make and use the described embodiments. Various modifications, however, will remain readily-apparent to those in the art.

Some embodiments address the foregoing problems by facilitating technical integration between a diagramming tool and a cloud service provider. This technical integration may improve the functionality of technical diagramming systems by allowing a novice user to generate accurate and useful cloud resource architecture diagrams. Conventional systems fail to provide this integration and therefore, as described above, require higher degrees of user sophistication to generate suitable architecture diagrams.

In one example of technical integration according to some embodiments, a user may simply input resource subscription information into a diagramming tool. In response, the diagramming tool establishes secure communication with a cloud service provider and requests appropriate resource information using functionality provided by the cloud service provider.

According to some embodiments, a system is provided for a diagramming tool to acquire desired resource metadata from a cloud service provider, and to generate cloud resource architecture diagrams therefrom. A system may efficiently employ secure protocols to request and acquire the resource metadata. Moreover, some embodiments allow for efficient selection of particular cloud resources for which to obtain metadata and depict in an architecture diagram. Embodiments may therefore promote efficient design, review and monitoring of technical aspects of cloud service deployments.

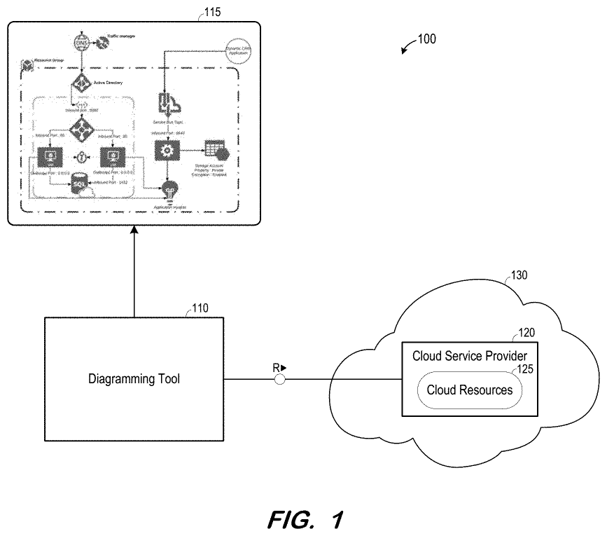

FIG. 1 illustrates system 100 according to some embodiments. System 100 includes diagramming tool 110 and cloud service provider 120. Cloud service provider 120 is accessible via internet 130 and provides cloud resources 125. Any network, resource, component or service described herein may consist of any number and types of networks, hardware components and software components which communicate with one another over any number and type of public (e.g., Internet) or private (e.g., on-premise) networks.

In operation, diagramming tool 110 transmits a request to cloud service provider 120 for metadata associated with cloud resources 125. As will be described below, the request may specify a particular subset of cloud resources 125 for which to acquire metadata. The request may be transmitted according to any authentication protocol that is or becomes known, including but not limited to token-based authentication. Assuming successful authentication, cloud service provider 120 then returns the metadata to diagramming tool 110. The metadata may specify dependencies and properties of a plurality of cloud resources 125. Examples of dependencies and properties will be provided below.

Diagramming tool 110 maps one or more of the plurality cloud resources to a resource icon based on corresponding dependencies and properties. For example, a property of a cloud resource may specify that the resource is a virtual machine. Other resource types include but are not limited to a storage account, a web application, a server and a database. The resource is therefore mapped to an icon of diagramming tool 110 which corresponds to a virtual machine.

Properties of the virtual machine resource may include a memory size, an operating system, a processor type, and any other suitable properties. A property may also specify another resource. For example, a network property of a virtual machine resource may specify a virtual network resource to which the virtual machine resource belongs, or a storage property of the virtual machine resource may specify a storage account resource which holds the virtual hard disks of the virtual machine resource.

For a given resource, there may be other resources that should exist before the resource is deployed. For example, a Structured Query Language (SQL) server resource should exist before attempting to deploy a SQL database resource. Accordingly, metadata defining a resource may specify other resources on which that resource depends.

A resource property may also specify child resources that are related to the resource being defined. Child resources may be defined using multiple hierarchical levels. Metadata of a server resource may define a database as a child resource of the server, for example.

Diagramming tool 110 then generates diagram 115 based on the resource metadata and the mapped resource icons. Diagramming tool 110 may determine the layout and interconnections of the icons of diagram 115 based on the properties and dependencies between the corresponding resources as specified in the resource metadata. Properties may also be depicted via labelling (e.g., ports, Internet Protocol addresses, security information) associated resource icons. Diagram 115 may be presented on a display device of a computing system executing diagramming tool 110.

Diagramming tool 110 may comprise a software application executed by a processing unit of a computing system. Diagramming tool 110 may comprise a standalone software application for creating diagrams and executing on a desktop, laptop or other computing device. Diagramming tool 110 may comprise a Web application executing on a Web server and accessed via a Web browser executing on a client device. In such an implementation, diagram 115 may be generated on the Web server hosting tool 110 and diagram 115 may be displayed on a display device of the client device.

Cloud service provider 120 may provide customers with Web-based services which may be characterized as infrastructure as a service (IaaS), software as a service (SaaS) and/or platform as a service (PaaS). IaaS may include Web-accessible infrastructure resources such as servers, storage and networking resources. Cloud service provider 120 may also provide monitoring, security, load balancing and storage resiliency to complement its IaaS offerings. PaaS may add cloud infrastructure and services such as operating systems and middleware to the underlying infrastructure. Finally, SaaS may include applications such as productivity suites, customer relationship management (CRM) software and human resources management (HRM) software.

Services offered by cloud service provider 120 (via cloud resources 125) may be self-provisioning and consumed on-demand. The services may be purchased as usage-based subscriptions, for example. According to some embodiments, cloud service provider 120 may reside in a user's on-premise data center and operate as described herein.

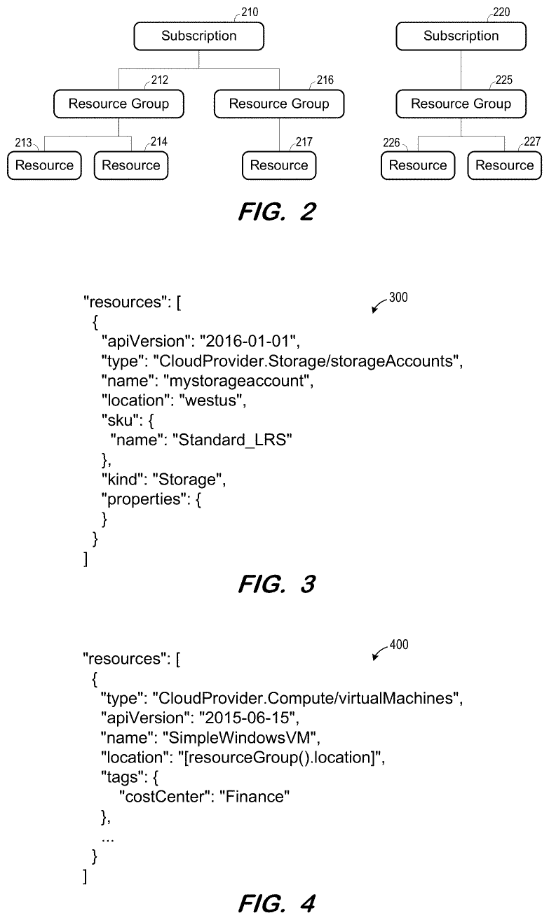

FIG. 2 includes representations of cloud service subscriptions and their relationships to resource groups and resources according to some embodiments. The representations may be defined by metadata which is stored within cloud service provider 120 and managed by a resource manager component of cloud service provider 120. Embodiments are not limited to the logical hierarchies of FIG. 2. Resources may be grouped according to any schema according to some embodiments.

Subscriptions 210 and 220 may be associated with a same or different customers of cloud service provider 120. In some embodiments, each of subscriptions 210 and 220 is associated with a different subscription reference number for invoicing purposes. For example, a customer is billed for each resource group and resource of a subscription under a single invoice. A single subscription may correspond to a single cloud service, but embodiments are not limited thereto.

Each subscription 210 and 220 is associated with one or more resource groups. A resource group may be considered a container which holds related resources of a cloud service. A resource group may include all the resources of a service (e.g., resource group 225) solution, or a subset of resources which may be desirable to manage as a group (e.g., resource groups 212 and 216). Allocation of resources to resource groups may be controlled by cloud service provider 120 or by a customer associated with the root subscription.

Resources may include, but are not limited to virtual machines, storage accounts, web applications, databases, servers, data factories, virtual networks, and key vaults. Some embodiments of cloud service provider 120 include a resource provider service which supplies resources and offers operations for interacting with the resources that are deployed. Dedicated resource providers may supply virtual machine resources, storage account resources, and resources related to web applications.

Each logical entity of the FIG. 2 hierarchies may be associated with a tag according to some embodiments. A tag may include a name and a value. For example, all resources associated with company ABC may be tagged with the name “Company” and the value “ABC”. A resource of one resource group may share a tag with a resource of another resource group. As will be described below, tags may be used to retrieve desired resources from a subscription for inclusion in an architecture diagram.

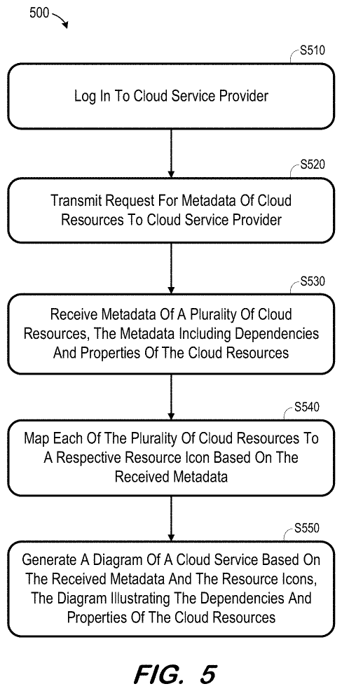

Each resource of a cloud service is associated with dependencies and properties. The dependencies and properties define the operational characteristics of a resource and the other resources on which it directly depends. FIGS. 3 and 4 are JavaScript Object Notation (JSON) representations of the dependencies and properties of two different resources 300 and 400 according to some embodiments. Resource 300 is a storage account and resource 400 is a virtual machine. Resource 400 is associated with a tag having the name “costCenter” and the value “Finance”.

FIG. 5 comprises a flow diagram of process 500 to generate a diagram of cloud resources according to some embodiments. In some embodiments, processing units (e.g., one or more processors, processing cores, processor threads) of a computing system execute software program code of a diagramming tool to cause the system to perform process 500. Execution of process 500 may be distributed among several computing nodes. Process 500 and all other processes mentioned herein may be embodied in processor-executable program code read from one or more of non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at S510, a customer logs in to a cloud service provider. The login is intended to create an authenticated and authorized communication channel between a diagramming tool and the cloud service provider according to some embodiments. In some embodiments, a customer operates a computing device at S510 to submit a username and password to a cloud service provider and receive an authentication token in return.

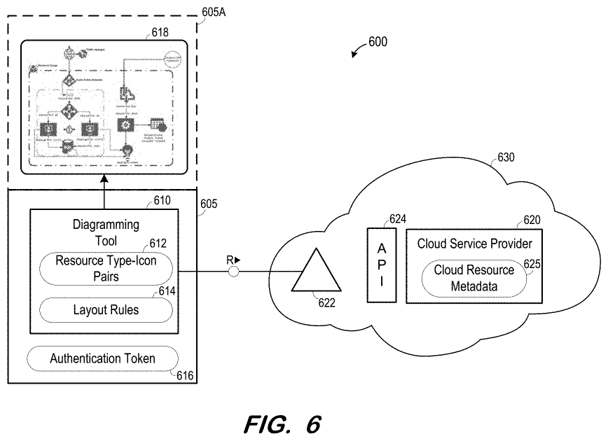

FIG. 6 illustrates system 600 to execute process 500 according to some embodiments. As shown in FIG. 6, computing system 605 has established authenticated communication with identity and access management service 622 associated with cloud service provider 620. As a result, computing system 605 now stores authentication token 616. Identity and access management service 622 may comprise a multi-tenant, cloud-based service providing core directory services, identity governance, and application access management.

Computing system 605 executes diagramming tool 610. According to some embodiments, and as described above, computing system 605 is a cloud-based server providing online access to diagramming tool 610. In such an implementation, the dashed line indicates a client computing system 605A executing a Web browser to access system 605 and to display diagram 618 generated by diagramming tool 610. In other implementations, system 605 and system 605A comprise a single standalone computing system.

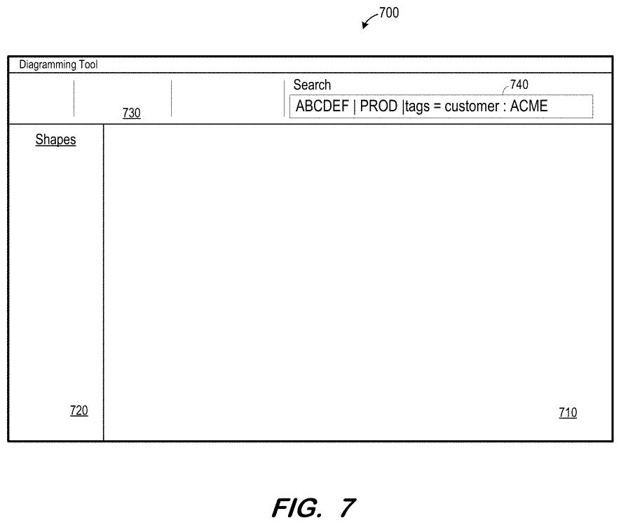

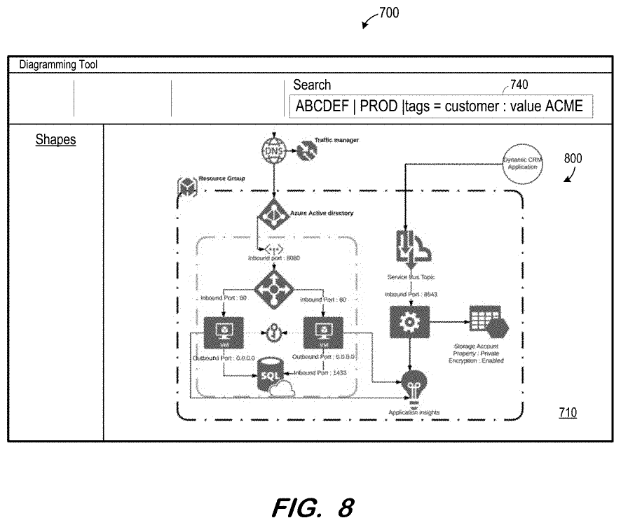

A request for metadata of cloud resources is transmitted to the cloud service provider at S520. Transmission of the request may be triggered by a command received by diagramming tool 610. FIG. 7 is a representation of user interface 700 of diagramming tool 610 according to some embodiments.

User interface 700 includes diagram area, shape dock 720, and function ribbon 730. Embodiments are not limited to the arrangement of elements shown in FIG. 7. User interface 700 also includes search bar 740. In the illustrated example, a user has entered a string into search bar 740: “ABCDEF|PROD|tags=customer: ACME”. According to the syntax of the example, the string is a search request for resource metadata of resources associated with the subscription “ABCDEF”, the resource group “PROD”, and with tags having the name “customer” and the value “ACME”. Embodiments may employ any suitable syntax or user interface metaphor for inputting a request to diagramming tool 610.

According to some embodiments, diagramming tool 610 transmits the search request at S520 by calling Application Programming Interfaces (APIs) 624 exposed by API component 624 associated with cloud service provider 630. APIs 624 may provide for querying cloud service provider 620 for cloud resource metadata, filtered by subscription, resource group, and/or tags.

In some embodiments of S520, the search request is transmitted by transmitting commands provided by a command-line shell session executing on system 605. The shell may provide commands for managing cloud resources in some embodiments. For example, the shell may provide commands for retrieving the resources of a resource group, and for retrieving the metadata of a particular resource. According to some embodiments, the cloud resource metadata is managed by a resource manager of cloud service provider 620. The resource manager may therefore provide APIs 624 and retrieve appropriate metadata based on the received search request.

Diagramming tool 610 receives results of the search request at S530. The results include metadata of a plurality of cloud resources (i.e., those cloud resources matching the search string and the subscription associated with authentication token 616). The metadata includes dependencies and properties of the cloud resources as described above. The metadata is provided in a format that may be parsed by diagramming tool 610 to extract the dependencies and properties.

Next, at S540, each of the plurality of cloud resources is mapped to a respective resource icon based on the received metadata. As described above, the metadata defines a type of each cloud resource. As shown in FIG. 6, diagramming tool 612 includes resource type-icon pairs which allow direct mapping between a resource of a certain resource type and an icon representing that resource.

A diagram of the cloud resources is generated at S550. The diagram is generated based on the received metadata and the mapped resource icons. In particular, the diagram illustrates a plurality of the dependencies included in the cloud resource metadata and a plurality of the properties of the cloud resources. FIG. 8 illustrates interface 700 including diagram 800 generated according to some embodiments.

Diagramming tool 610 of FIG. 6 utilizes layout rules 614 to determine the layout of the icons in the generated diagram, their interconnections, and the properties to be displayed along with the icons. Layout rules 614 may employ any techniques that are or become known for generating a diagram of nodes having known interconnections. In some embodiments, layout rules 614 also indicate, for each resource type, one or more property values which should be displayed along with the icon of the resource type. For example, layout rules 614 may specify that a virtual machine resource is represented by a particular icon accompanied by text indicating its input port address and output port address. In another example, a storage account resource may be represented by a particular icon and text indicating its security settings (e.g., private, encryption enabled).

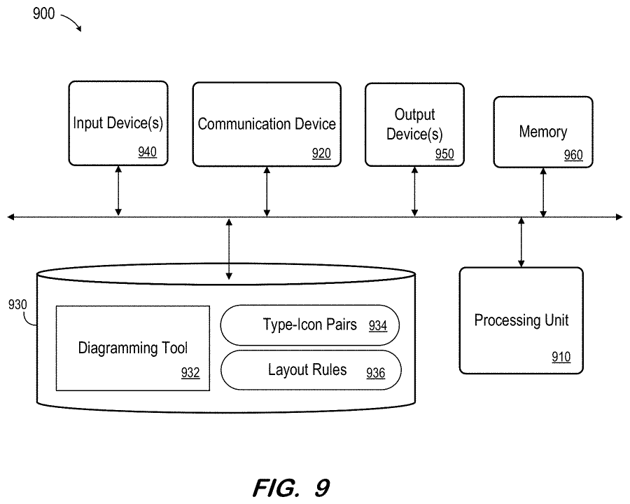

FIG. 9 is a block diagram of system 900 according to some embodiments. System 900 may comprise a server and may execute program code to generate diagrams using any of the processes described herein. Any one or more components of system 900 may be implemented in a distributed architecture. System 900 may include other unshown elements according to some embodiments.

System 900 includes processing unit 910 operatively coupled to communication device 920, persistent data storage system 930, one or more input devices 940, one or more output devices 950 and volatile memory 960. Processing unit 910 may comprise one or more processors, processing cores, etc. for executing program code. Communication device 920 may facilitate communication with external networked devices, such as a cloud service provider. Input device(s) 940 may comprise, for example, a keyboard, a keypad, a mouse or other pointing device, a microphone, a touch screen, and/or an eye-tracking device. Output device(s) 950 may comprise, for example, a display (e.g., a display screen), a speaker, and/or a printer.

Data storage system 930 may comprise any number of appropriate persistent storage devices, including combinations of magnetic storage devices (e.g., magnetic tape, hard disk drives and flash memory), optical storage devices, Read Only Memory (ROM) devices, etc. Memory 960 may comprise Random Access Memory (RAM), Storage Class Memory (SCM) or any other fast-access memory.

Diagramming tool 932 may comprise program code executed by processing unit 910 to cause system 900 to perform any one or more of the processes described herein. For example, program code of diagramming tool 932 may be executed to request and receive metadata describing cloud resources. Program code of diagramming tool 932 may further be executed to generate diagrams based on such received metadata. Data storage device 930 may also store data and other program code for providing additional functionality and/or which are necessary for operation of system 900, such as device drivers, operating system files, etc.

Each functional component described herein may be implemented in computer hardware (integrated and/or discrete circuit components), in program code and/or in one or more computing systems executing such program code as is known in the art. Such a computing system may include one or more processing units which execute processor-executable program code stored in a memory system.

The above-described diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions.

Embodiments described herein are solely for the purpose of illustration. Those in the art will recognize other embodiments may be practiced with modifications and alterations to that described above.

1. An apparatus comprising:
a memory storing processor-executable process steps of a diagramming tool;
one or more processors to execute the processor-executable process steps to cause the apparatus to:
transmit, to a cloud service provider, a request for metadata associated with cloud resources associated with a cloud service subscription and a cloud resource group;
receive the metadata associated with at least two cloud resources from the cloud service provider, the metadata associated with the cloud service subscription and the cloud resource group, and comprising one or more dependencies and properties associated with each of the at least two cloud resources;
determine a resource type of each of the at least two cloud resources based on the received metadata;
determine an icon associated with the resource type of each of the at least two cloud resources;
for each determined icon, determine a property value type to depict adjacent to the icon based on the resource type of the cloud resource associated with the icon, where, if the resource type is a first resource type, a first property value type and not a second property value type is determined and, if the resource type is a second resource type, the second property value type and not the first property value type is determined; and
automatically generate a diagram of the determined icons and adjacent property value types, the diagram depicting at least one of the one or more dependencies and properties of the at least two cloud resources.

2. An apparatus according to claim 1, wherein the one or more processors is to execute the processor-executable process steps to cause the apparatus to:
acquire an authentication token associated with the cloud service subscription prior to transmission of the request for metadata,
wherein the request for metadata comprises the authentication token.

3. An apparatus according to claim 2, wherein the request for metadata identifies a tag name and tag value, and
wherein the at least two cloud resources are associated with the tag name and tag value.

4. An apparatus according to claim 1, wherein transmission of the request comprises transmission of an authorization token to the cloud service provider.

5. (canceled)

6. (canceled)

7. A method comprising:
requesting, over an authenticated communication channel, information associated with at least two cloud resources of a cloud service provider, the at least two cloud resources associated with a cloud service subscription and a resource group;
receiving the information, the information comprising a resource type and one or more dependencies and properties associated with each of the at least two cloud resources;
determining an icon associated with the resource type of each of the at least two cloud resources;
for each determined icon, determining a property value type to depict adjacent to the icon based on the resource type of the cloud resource associated with the icon, where, if the resource type is a first resource type, a first property value type and not a second property value type is determined and, if the resource type is a second resource type, the second property value type and not the first property value type is determined; and
automatically generating a diagram of the determined icons and adjacent property value types, the diagram depicting at least one of the one or more dependencies and properties of the one or more cloud resources.

8. A method according to claim 7, wherein requesting the information comprises specifying the cloud service subscription and the resource group.

9. A method according to claim 8, wherein requesting the information comprises specifying a tag name and tag value, and
wherein the one or more cloud resources are associated with the tag name and tag value.

10. A method according to claim 7, wherein requesting the information comprises transmitting an authorization token to the cloud service provider.

11. (canceled)

12. (canceled)

13. A computing device to:
execute program code of a diagramming tool to transmit a search request for at least two cloud resources of a cloud resource group to a cloud service provider;
receive the results of the search request from the cloud service provider, the results comprising one or more dependencies and properties associated with each of the at least two cloud resources;
determine a resource type of each of the at least two cloud resources based on the received results;
determine an icon associated with the resource type of each of the at least two cloud resources;
for each determined icon, determine a property value type to depict adjacent to the icon based on the resource type of the cloud resource associated with the icon, where, if the resource type is a first resource type, a first property value type and not a second property value type is determined and, if the resource type is a second resource type, the second property value type and not the first property value type is determined; and
automatically generate a diagram of the determined icons and adjacent property value types, the diagram depicting at least one of the one or more dependencies and properties of the at least two cloud resources.

14. A computing system according to claim 13, wherein the search request identifies the cloud service subscription and the resource group, and
wherein the at least two cloud resources are associated with the subscription and the resource group.

15. A computing system according to claim 14, wherein the search request identifies a tag name and tag value, and
wherein the at least two cloud resources are associated with the tag name and tag value.

16. A computing system according to claim 13, wherein transmission of the search request comprises transmission of an authorization token to the cloud service provider.

17. (canceled)

18. (canceled)
